(19) United States
(12) Patent Application Publication
(10) Pub. No.: US 2022/0283593 A1
(43) Pub. Date: Sep. 8, 2022

(54) ELECTRONIC CONTROL DEVICE

(71) Applicant: Hitachi Astemo, Ltd., Hitachinaka-shi, Ibaraki (JP)

(72) Inventors: Hidetoshi TERAOKA, Tokyo (JP); Keisuke AMPO, Hitachinaka-shi (JP); Takeyuki TOMINAGA, Hitachinaka-shi (JP)

(73) Assignee: Hitachi Astemo, Ltd., Hitachinaka-shi, Ibaraki (JP)

(21) Appl. No.: 17/636,202

(22) PCT Filed: Jul. 28, 2020
(86) PCT No.: PCT/JP2020/028888

§ 371 Date: Feb. 17, 2022

(30) Foreign Application Priority Data
Aug. 28, 2019 (JP) 2019-155866

(51) Int. Cl. G05D 1/02; G01C 21/36; G08G 1/0969

(52) U.S. Cl. CPC G05D 1/0274; G01C 21/36; G08G 1/0969

(57) ABSTRACT

Provided is an electronic control device that acquires route information to a destination based on first map information, and when a part of the route to the destination is outside a map range of any one of the first map information and second map information having a map range different from the first map information, changes the destination to generate a route to the destination based on the second map information.

### TECHNICAL FIELD

The present invention relates to an electronic control device.

### BACKGROUND ART

A device that searches for a route to a destination using map information and guides a vehicle to the destination according to the searched route is being widely used. Such a device has a problem that a route search cannot be performed if there is a place where map information cannot be acquired between the current location and the destination.

As a conventional technique related to the present invention, for example, PTL 1 is known. PTL 1 discloses a route search device that stores detailed map data with which a short-distance route can be searched for separately from normal map data, sets a temporary destination ahead by a certain distance along a road on which the vehicle is traveling until a search for a new route is completed when the current location deviates from the route, and searches for a temporary route based on the detailed map data.

### CITATION LIST

### Patent Literature

PTL 1: JP 2017-110924 A

### SUMMARY OF INVENTION

### Technical Problem

The technique described in PTL 1 can resolve a state in which there is no route when deviating from the route in a short time, but does not allow a route to be searched for a place where map information cannot be acquired. Therefore, the above-described problem cannot be solved, and an appropriate route cannot be provided.

In view of such a problem, an object of the present invention is to provide an appropriate route even when there is a place where map information cannot be acquired.

### Solution to Problem

An electronic control device according to the present invention acquires route information to a destination based on first map information, and when a part of the route to the destination is outside a map range of any one of the first map information and second map information having a map range different from the first map information, changes the destination to generate a route to the destination based on the second map information.

### Advantageous Effects of Invention

According to the present invention, an appropriate route can be provided even when there is a place where map information cannot be acquired.

### BRIEF DESCRIPTION OF DRAWINGS

FIG. 1 is a functional block diagram illustrating an example of a functional configuration of a route search system according to a first embodiment of the present invention.

FIG. 2 is a diagram illustrating an example of a map for explaining the operation of the route search system according to the first embodiment of the present invention.

FIG. 3 is a diagram illustrating an example of a conversion table used in the route search system according to the first embodiment of the present invention.

FIG. 4 is a flowchart of processing performed by a high-precision map management device in the route search system according to the first embodiment of the present invention.

FIG. 5 is a diagram for explaining an outline of a second embodiment of the present invention.

FIG. 6 is a flowchart of processing performed by a high-precision map management device in a route search system according to the second embodiment of the present invention.

FIG. 7 is a flowchart of processing performed by a server device in a route search system according to a third embodiment of the present invention.

FIG. 8 is a diagram illustrating an example of a conversion table used in the route search system according to the third embodiment of the present invention.

FIG. 9 is a flowchart of processing performed by a high-precision map management device in the route search system according to the third embodiment of the present invention.

### DESCRIPTION OF EMBODIMENTS

Hereinafter, embodiments of the present invention will be described with reference to the drawings.

### First Embodiment

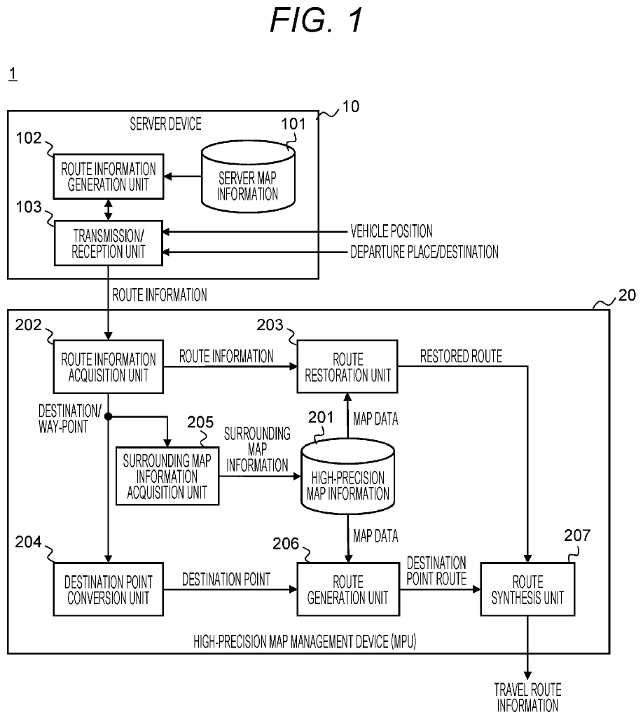

FIG. 1 is a functional block diagram illustrating an example of a functional configuration of a route search system 1 according to a first embodiment of the present invention. The route search system 1 of the present embodiment includes a server device 10 and a high-precision map management device 20. The server device 10 is installed at a predetermined place such as a data center. The high-precision map management device 20 is a type of electronic control device (electronic control unit (ECU)) mounted on a vehicle, and is configured using, for example, a micro processing unit (MPU) or the like. The server device 10 and the high-precision map management device 20 are connected to each other via a public communication network such as a mobile phone line or the Internet. In this system, a plurality of vehicles equipped with the high-precision map management device 20 is managed.

The server device 10 includes a server map database (hereinafter, referred to as a “server map DB”) 101, a route information generation unit 102, and a transmission/reception unit 103. The server map DB 101 stores server map information used in the server device 10. Using the server map information stored in the server map DB 101, the route information generation unit 102 searches for a route from the current position of the vehicle to the destination via the departure place designated by the user, and generates route information representing the searched route. Note that the route information generated by the route information generation unit 102 includes information on the searched route and information on the departure place and the destination designated by the user. Furthermore, in a case where a way-point is set between the departure place and the destination, information on the way-point is also included. The transmission/reception unit 103 receives information on the departure place and the destination designated by the user through operation of an information terminal such as a smartphone and position information of a vehicle to be managed, outputs the information to the route information generation unit 102, and transmits the route information generated by the route information generation unit 102 to the high-precision map management device 20. In the present example, an example in which the departure place and the current location of the vehicle are the same will be described.

For example, the user can designate the current location as a departure place and designate an arbitrary facility as a destination. The facility to be the destination can be designated, for example, by inputting a facility name or by designating on a map displayed on the information terminal. In the present embodiment, a case where the high-precision map management device 20 is mounted on a taxi operated by automatic driving, and a user calls the taxi by operating an information terminal to move to an arbitrary destination facility will be described as an example.

The high-precision map management device 20 includes a high-precision map database (hereinafter, referred to as a “high-precision map DB”) 201, a route information acquisition unit 202, a route restoration unit 203, a destination point conversion unit 204, a surrounding map information acquisition unit 205, a route generation unit 206, and a route synthesis unit 207.

The high-precision map DB 201 stores high-precision map information used in the high-precision map management device 20. The high-precision map information stored in the high-precision map DB 201 is map information used for automatic driving of a vehicle or the like, and represents a map with higher precision than the above-described server map information used by the server device 10. For example, map information including detailed position information for every lane of each road, information on the advancing direction of each lane, passage information in the facility, and the like are stored in the high-precision map DB 201 as the high-precision map information.

The route information transmitted from the server device 10 is received by a communication device (not illustrated) (telematics control unit (TCU)) mounted on the vehicle, and is output to the high-precision map management device 20. The route information acquisition unit 202 acquires the route information received by the communication device via a predetermined communication interface provided between the communication device and the high-precision map management device 20. Then, the acquired route information is output to the route restoration unit 203, and information on destination facilities and way-points included in the route information is output to the destination point conversion unit 204 and the surrounding map information acquisition unit 205. Note that a controller area network (CAN) or the like, for example, is used as the predetermined communication interface.

The route restoration unit 203 restores the route searched in the server device 10 based on the route information acquired by the route information acquisition unit 202. At this time, the route restoration unit 203 acquires map data of a necessary range from the high-precision map information stored in the high-precision map DB 201, and uses such map data to restore a route. As a result, the route searched on the server map by the server device 10 is restored as a route on the high-precision map that can be used for automatic driving. The route restoration unit 203 outputs the restored route on the high-precision map thus obtained to the route synthesis unit 207.

The destination point conversion unit 204 specifies a point (hereinafter referred to as “destination point”) on the high-precision map corresponding to the facility designated as the destination by the user based on the information of the destination facility included in the route information acquired by the route information acquisition unit 202. Then, information of the specified destination point is output to the route generation unit 206. As a result, a point corresponding to the facility specified on the server map in the route search of the server device 10 is converted into a destination point corresponding to the facility on the high-precision map. Note that details of the conversion from the destination facility to the destination point by the destination point conversion unit 204 will be described later.

The surrounding map information acquisition unit 205 determines whether or not high-precision map information (hereinafter, referred to as “surrounding map information”) around the destination facility is stored in the high-precision map DB 201 based on the information of the destination facility included in the route information acquired by the route information acquisition unit 202. When it is determined that the surrounding map information is not stored in the high-precision map DB 201 as a result, the surrounding map information is acquired and stored in the high-precision map DB 201. At this time, the surrounding map information acquisition unit 205 can acquire necessary surrounding map information, for example, by requesting surrounding map information to a server device (not illustrated) different from the server device 10 and receiving surrounding map information distributed from the server device in response to the request.

The route generation unit 206 generates a route (hereinafter referred to as a “destination point route”) from the end point of the route represented by the route information to the destination point specified by the destination point conversion unit 204 based on the surrounding map information stored in the high-precision map DB 201. As a result, when a route to the destination facility cannot be searched in the route search of the server device 10 and a route to the end point set in front of the destination facility is searched, a destination point route from the end point to the destination point is generated on the high-precision map. Note that details of the destination point route generated by the route generation unit 206 will be described later. The route generation unit 206 outputs the destination point route on the high-precision map thus obtained to the route synthesis unit 207.

The route synthesis unit 207 synthesizes the restored route on the high-precision map obtained by the route restoration unit 203 and the destination point route on the high-precision map obtained by the route generation unit 206 to generate the entire route from the departure place to the destination point based on the high-precision map information. Then, the travel route information representing the obtained entire route is transmitted to an automatic driving control device (not illustrated) mounted on the vehicle. Note that, for example, CAN or the like is used as a communication interface at this time, as in the case where the route information is transmitted from the communication device to the route information acquisition unit 202.

In the route search system 1 of the present embodiment, each function as described above is realized in the server device 10 and the high-precision map management device 20. Thus, information on a route on which the vehicle can travel by automatic driving from the departure place to the facility of the destination designated by the user can be obtained.

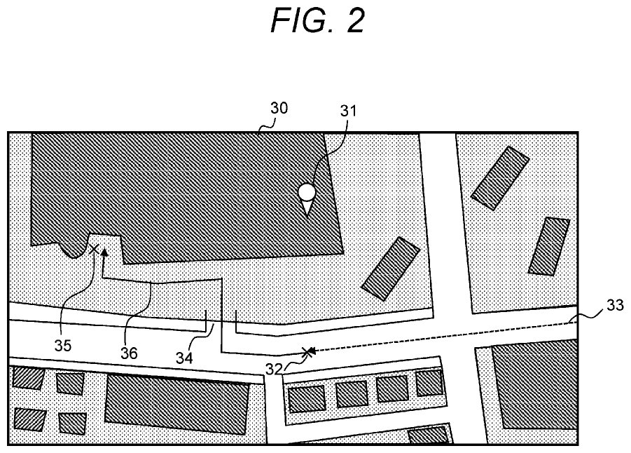

Next, a specific example of the route search by the route search system 1 of the present embodiment will be described with reference to FIG. 2. FIG. 2 is a diagram illustrating an example of a map for explaining the operation of the route search system 1 according to the first embodiment of the present invention.

In the map of FIG. 2, a reference numeral 30 represents a facility provided with a facility entrance 35 that can be used as a stopping place of a taxi, such as a shopping mall, a station, an airport, or a hotel. In the server map information used by the server device 10, it is assumed that a representative point indicated by a reference numeral 31 is registered as a point representing the facility 30. In the site of the facility 30, a vehicle passage is provided between the entrance gate 34 and the facility entrance 35, but it is assumed that information on the vehicle passage is not recorded in the server map information. When the user designates the facility 30 as the destination under such a situation, in the server device 10, the representative point 31 of the facility 30 is set as the destination, and a point 32 on the road closest to the representative point 31 around the facility 30 is set as the end point, and a route 33 to the end point 32 is searched.

When the route information on the route 33 searched in the server device 10 is transmitted from the server device 10 to the high-precision map management device 20, the destination point conversion unit 204 converts the representative point 31 to the destination point based on the information of the destination included in the route information in the high-precision map management device 20. At this time, the destination point conversion unit 204 refers to a conversion table set in advance to specify the facility entrance 35 as a significant destination point corresponding to the facility 30 set as the destination on the high-precision map.

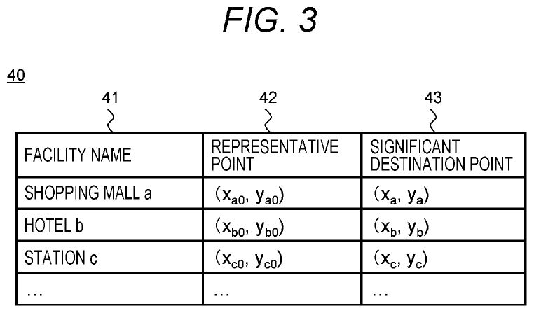

FIG. 3 is a diagram illustrating an example of a conversion table used by the destination point conversion unit 204 in the route search system 1 according to the first embodiment of the present invention. The conversion table 40 illustrated in FIG. 3 includes fields of a facility name 41, a representative point 42, and a significant destination point 43 for each record set for every facility. The name of each facility is stored in the facility name 41. The coordinate value of the representative point corresponding to each facility is stored in the representative point 42. The significant destination point 43 stores a coordinate value of a significant destination point on the high-precision map corresponding to each facility.

Note that the conversion table illustrated in FIG. 3 is an example, and the present invention is not limited thereto. In the route search system 1 of the present embodiment, any form of conversion table may be used in the destination point conversion unit 204 as long as a point corresponding to an arbitrary facility on the server map can be converted into a significant destination point corresponding to the facility on the high-precision map. In addition, the conversion table may be stored in advance in a place other than the destination point conversion unit 204, or may be arbitrarily acquired from another device similarly to the surrounding map information acquired by the surrounding map information acquisition unit 205.

The destination point conversion unit 204 acquires the facility name of the facility 30 and the coordinate value of the representative point 31 as information of the destination included in the route information, and searches the conversion table 40 for a record in which the facility name 41 and the representative point 42 that match them are set. Then, the coordinate value of the facility entrance 35 is specified as the coordinate value of the destination point corresponding to the facility 30 by referring to the significant destination point 43 of the record. As a result, the representative point 31 set at the destination as the point corresponding to the facility 30 on the server map is converted into another point corresponding to the facility 30 on the high-precision map, that is, the facility entrance 35.

When the destination is converted from the representative point 31 to the facility entrance 35 as described above, the route generation unit 206 searches for a route from the end point 32 of the route 33 represented by the route information received from the server device 10 to the facility entrance 35, which is the destination after conversion, using the high-precision map information stored in the high-precision map DB 201. As a result, as illustrated in FIG. 2, a destination point route 36 from the end point 32 to the facility entrance 35 of the destination point through the entrance gate 34 is searched.

On the other hand, the route 33 represented by the route information received from the server device 10 is restored as a route from the departure place to the end point 32 based on the high-precision map information by the route restoration unit 203. The restored route 33 and the destination point route 36 from the end point 32 to the facility entrance 35 generated by the route generation unit 206 are synthesized by the route synthesis unit 207, so that the entire route from the departure place to the facility entrance 35 is generated on the high-precision map.

In the route search system 1 of the present embodiment, by performing the processing described above, a route can be set on the high-precision map by the high-precision map management device 20 mounted on the vehicle side even in the site of the facility 30 where map information cannot be acquired by the server device 10 that performs a route search in response to a request from a user. Therefore, the automatic driving of the vehicle can be realized in the optimum route for delivering the user to the facility 30.

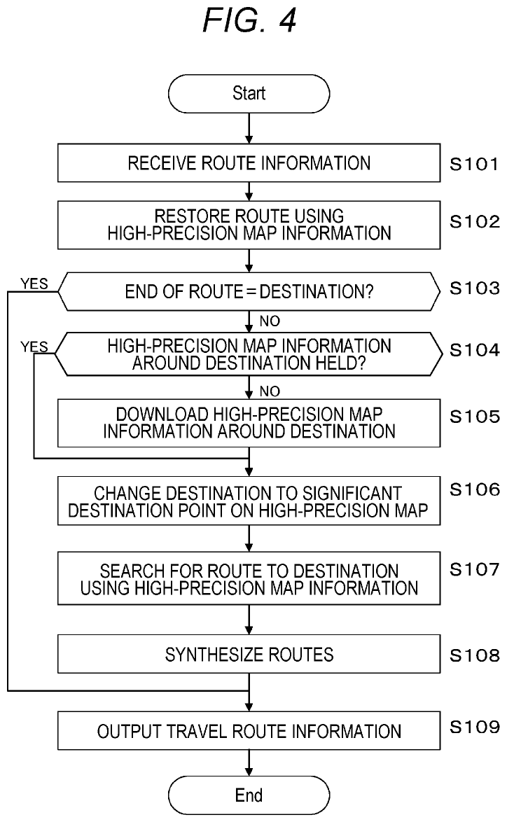

FIG. 4 is a flowchart of processing performed by the high-precision map management device 20 in the route search system 1 according to the first embodiment of the present invention. When the route information is transmitted from the server device 10, the high-precision map management device 20 of the present embodiment executes the processing illustrated in the flowchart of FIG. 4 accordingly.

In step S101, the high-precision map management device 20 causes the route information acquisition unit 202 to receive and acquire the route information transmitted from the server device 10.

In step S102, the high-precision map management device 20 causes the route restoration unit 203 to restore a route using the high-precision map information stored in the high-precision map DB 201 based on the route information received in step S101.

In step S103, the high-precision map management device 20 determines whether or not the end of the route restored in step S102 is the destination. When the end of the route is the destination, the process proceeds to step S109, and when the end of the route is not the destination, that is, when the point set in front of the destination is the end point of the route, the process proceeds to step S104.

In step S104, the high-precision map management device 20 causes the surrounding map information acquisition unit 205 to determine whether or not the high-precision map information around the destination is held in the high-precision map DB 201 based on the route information received in step S101. For example, when the map information of the site for the facility 30 described with reference to FIG. 2 is held as the surrounding map information in the high-precision map DB 201, the process proceeds to step S106, and when it is not held, the process proceeds to step S105.

In step S105, the high-precision map management device 20 causes the surrounding map information acquisition unit 205 to download and acquire high-precision map information around the destination from a server device (not illustrated). The downloaded high-precision map information is stored in the high-precision map DB 201 as surrounding map information.

In step S106, the high-precision map management device 20 causes the destination point conversion unit 204 to change the destination of the route represented by the route information received in step S101 to a significant destination point on the high-precision map. Here, for example, using the conversion table described in FIG. 3 described above, the facility entrance 35 corresponding to the facility 30 designated as the destination is specified as a significant destination point, and the facility entrance 35 is set as the destination after the change.

In step S107, the high-precision map management device 20 causes the route generation unit 206 to search for a route from the end point of the route restored in step S102 to the destination after the change set in step S106 using the high-precision map information stored in the high-precision map DB 201. Here, for example, for the facility 30 described in FIG. 2, a route from the end point 32 to the facility entrance 35 is searched using the surrounding map information of the facility 30 in the high-precision map information stored in the high-precision map DB 201.

In step S108, the high-precision map management device 20 causes the route synthesis unit 207 to synthesize the route restored in step S102 and the route searched in step S107, thereby generating the entire route from the departure place to the destination after the change. As a result, for example, as described with reference to FIG. 2, for the facility 30 designated as the destination, the entire route from the departure place to the facility entrance 35 through the entrance gate 34 is generated on the high-precision map.

In step S109, the high-precision map management device 20 outputs travel route information for causing the vehicle to travel to the destination by automatic driving to an automatic driving control device (not illustrated). At this time, when it is determined in step S103 that the end of the restored route is the destination, the information of the restored route is output as the travel route information. On the other hand, when it is determined in step S103 that the end of the restored route is not the destination, information of the entire route obtained by synthesizing the restored route and the destination point route in step S108 is output as the travel route information.

Upon completion of the processing of step S109, the high-precision map management device 20 terminates the processing illustrated in the flowchart of FIG. 4.

The first embodiment of the present invention described above has the following operation effects.

(1) The high-precision map management device 20, which is an electronic control device, acquires route information to a destination based on server map information (first map information) (step S101), and when a part of the route to the destination is outside the map range of the server map information (step S103: No), changes the destination (step S106), and generates a route to the destination based on the high-precision map information (second map information) having a map range different from the server map information (step S107). With this configuration, even when there is a place where the server device 10 cannot acquire the server map information, an appropriate route can be provided.

(2) The high-precision map information used by the high-precision map management device 20 is map information with higher precision than the server map information. With this configuration, highly accurate vehicle control can be realized using the high-precision map information.

(3) The high-precision map information used by the high-precision map management device 20 is map information used for automatic driving of the vehicle. The automatic driving of the vehicle thus can be realized using the high-precision map information.

(4) The route information acquired by the high-precision map management device 20 represents a route to the facility 30 designated as a destination by the user. When a part of the route to the destination is outside the map range of the server map information, the high-precision map management device 20 changes the destination from the representative point 31, which is a point corresponding to the facility 30 on the server map information, to another point corresponding to the facility 30 on the high-precision map information. With this configuration, the destination set on the server map information can be changed to another point significant when searching for a route on the high-precision map information.

(5) The high-precision map management device 20 includes a route information acquisition unit 202, a route restoration unit 203, a destination point conversion unit 204, a route generation unit 206, and a route synthesis unit 207. The route information acquisition unit 202 acquires route information including information on a destination designated by the user and information on a route to the end point 32 set around the facility 30 based on the server map information. The route restoration unit 203 restores the route 33 (first partial route) to the end point 32 based on the information on the route to the end point 32 included in the route information and the high-precision map information stored in the high-precision map DB 201. The destination point conversion unit 204 converts the representative point 31 corresponding to the facility 30 on the server map information into the facility entrance 35 which is a destination point corresponding to the facility 30 on the high-precision map information based on the information on the destination included in the route information. The route generation unit 206 generates a destination point route 36 (second partial route) from the end point 32 to the facility entrance 35 based on the high-precision map information. The route synthesis unit 207 synthesizes the route 33 and the destination point route 36 to generate a route to the destination. With this configuration, the entire route from the departure place to the facility entrance 35 through the entrance gate 34 can be generated on the high-precision map information for the facility 30 designated as the destination.

(6) The high-precision map management device 20 changes information on the destination in the server map information included in the route information to information on the destination in the high-precision map information. With this configuration, the destination set on the server map information can be changed to an appropriate destination on the high-precision map information.

### Second Embodiment

Next, a route search system according to a second embodiment of the present invention will be described. The route search system of the present embodiment has a functional configuration similar to that of the route search system 1 of the first embodiment described with reference to FIG. 1. Therefore, the route search system of the present embodiment will be described below with reference to the functional configuration of FIG. 1.

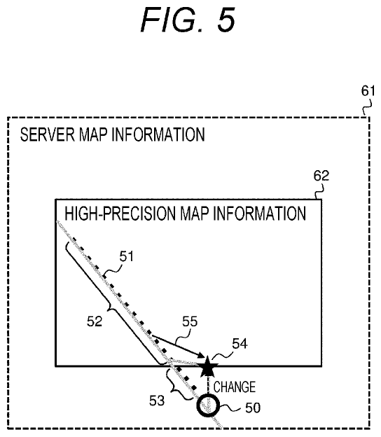

FIG. 5 is a diagram for explaining an outline of a second embodiment of the present invention. In FIG. 5, a range indicated by a reference numeral 61 represents a map range (hereinafter, referred to as a “server map range”) covered by the server map information stored in the server map DB 101 in the server device 10. In addition, a range indicated by a reference numeral 62 represents a map range (hereinafter, referred to as a “high-precision map range”) covered by the high-precision map information stored in the high-precision map DB 201 in the high-precision map management device 20. Hereinafter, as illustrated in FIG. 5, an outline of the present embodiment will be described assuming a case where the destination 50 designated by the user is set outside the range of the high-precision map range 62 and within the range of the server map range 61 in a situation where the high-precision map range 62 is narrower than the server map range 61.

In the case of FIG. 5, the server device 10 searches for a route 51 from the departure place to the destination 50 using the server map information, and transmits route information representing the route 51 to the high-precision map management device 20. When the route information is received by the route information acquisition unit 202, the high-precision map management device 20 causes the route restoration unit 203 to restore the route 51 on the high-precision map. However, since the destination 50 is outside the range of the high-precision map range 62, the partial route 52 to the boundary of the high-precision map range 62 in the route 51 can be restored, but the remaining partial route 53 cannot be restored on the high-precision map.

When a part of the route represented by the route information received from the server device 10 cannot be restored on the high-precision map as described above, the high-precision map management device 20 of the present embodiment changes the destination so as to be within the high-precision map range, and searches for a route from the middle of the restored route to the destination after the change. Specifically, the destination point conversion unit 204 changes the destination 50 from the outside of the range of the high-precision map range 62 to the closest destination point 54 on the outer periphery of the high-precision map range 62. Then, the route generation unit 206 searches for a route 55 from the middle of the partial route 52 to the destination point 54 as a destination point route. The route synthesis unit 207 synthesizes the restored partial route 52 and the destination point route 55 to generate an entire route from the departure place to the destination point 54.

The route search system 1 of the present embodiment can set a route on the high-precision map even when the destination 50 designated by the user is outside the range of the high-precision map range 62 by performing the processing described above. Therefore, automatic driving of the vehicle can be realized within a range possible when delivering the user to the destination 50.

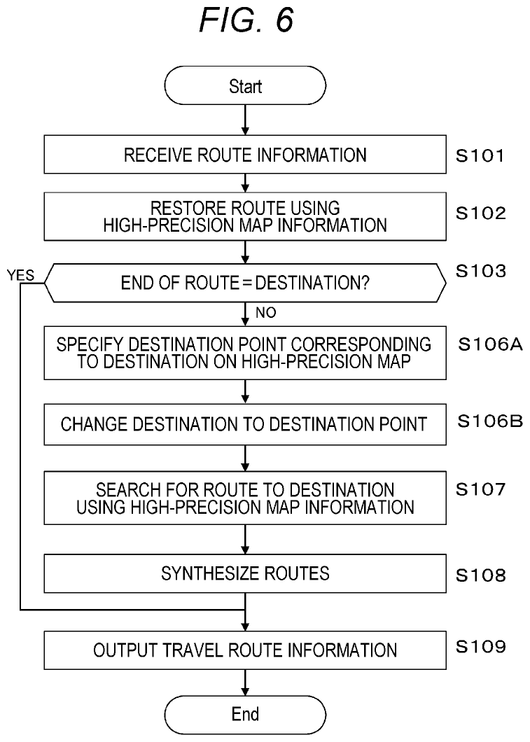

FIG. 6 is a flowchart of processing performed by the high-precision map management device 20 in the route search system 1 according to the second embodiment of the present invention. When the route information is transmitted from the server device 10, the high-precision map management device 20 of the present embodiment executes the processing illustrated in the flowchart of FIG. 6 accordingly. Note that, in the flowchart of FIG. 6, a portion that performs the same processing as the flowchart of FIG. 4 described in the first embodiment is denoted with a step number common with FIG. 4. Therefore, the flowchart of FIG. 6 will be described below while omitting the step numbers common with those in FIG. 4.

In FIG. 6, in a case where it is determined in step S103 that the end of the route is not the destination, the process proceeds to step S106A. In step S106A, the high-precision map management device 20 causes the destination point conversion unit 204 to specify the destination point corresponding to the destination of the route represented by the route information received in step S101 on the high-precision map. Here, for example, as described above with reference to FIG. 5, the point 54 closest to the destination 50 on the outer periphery of the high-precision map range 62 is specified as the destination point corresponding to the destination 50.

In step S106B, the high-precision map management device 20 causes the destination point conversion unit 204 to change the destination of the route represented by the route information received in step S101 to the destination point specified in step S106A. As a result, the destination of the route 51 is changed from, for example, the destination 50 outside the range of the high-precision map range 62 illustrated in FIG. 5 to the destination point 54 within the range of the high-precision map range 62.

After executing the processing of step S106B, the process proceeds to step S107, and the processing similar to that described in the first embodiment is performed. As a result, for example, as described with reference to FIG. 5, the entire route from the departure place to the destination point 54 is generated on the high-precision map with respect to the destination 50 designated by the user at outside the range of the high-precision map range 62.

Upon completion of the processing of step S109, the high-precision map management device 20 terminates the processing illustrated in the flowchart of FIG. 6.

The second embodiment of the present invention described above has the following operation effects.

(1) The high-precision map management device 20, which is an electronic control device, acquires route information to a destination based on server map information (first map information) (step S101), and when a part of the route to the destination is outside a map range of high-precision map information (second map information) having a map range different from the server map information (step S103: No), changes the destination (steps S106A and 106B), and generates a route to the destination based on the high-precision map information (step S107). With this configuration, even in a case where there is a place where the high-precision map information cannot be acquired by the high-precision map management device 20, an appropriate route can be provided.

(2) The high-precision map information used by the high-precision map management device 20 is map information with higher precision than the server map information. With this configuration, similarly to the first embodiment, highly accurate vehicle control can be realized using high-precision map information.

(3) The high-precision map information used by the high-precision map management device 20 is map information used for automatic driving of the vehicle. With this configuration, similarly to the first embodiment, the automatic driving of the vehicle can be realized using the high-precision map information.

(4) In a case where a part of the route 51 to the destination 50 is outside the map range of the high-precision map information, that is, the range of the high-precision map range 62, the high-precision map management device 20 changes the destination to the destination point 54 which is a point within the range of the high-precision map range 62. With this configuration, even if the destination set on the server map information is outside the map range of the high-precision map information, the point can be changed to a point expressible on the high-precision map information.

(5) The high-precision map management device 20 includes a route information acquisition unit 202, a route restoration unit 203, a destination point conversion unit 204, a route generation unit 206, and a route synthesis unit 207. The route information acquisition unit 202 acquires route information including information on the route 51 to the destination 50 based on the server map information. The route restoration unit 203 restores, based on the route information acquired by the route information acquisition unit 202 and the high-precision map information stored in the high-precision map DB 201, a partial route 52 (first partial route) to the boundary of the high-precision map range 62 of the route 51 to the destination 50. The destination point conversion unit 204 converts the destination 50 into a destination point 54 closest to the destination 50 on the outer periphery of the high-precision map range 62. The route generation unit 206 generates a destination point route 55 (second partial route) to the destination point 54 based on the high-precision map information. The route synthesis unit 207 synthesizes the partial route 52 and the destination point route 55 to generate a route to the destination. With this configuration, the entire route can be generated within a range expressible on the high-precision map information with respect to the destination designated outside the map range of the high-precision map information.

(6) The high-precision map management device 20 changes information on the destination in the server map information included in the route information to information on the destination in the high-precision map information. With this configuration, similarly to the first embodiment, the destination set on the server map information can be changed to an appropriate destination on the high-precision map information.

### Third Embodiment

Next, a route search system according to a third embodiment of the present invention will be described. The route search system of the present embodiment has a functional configuration similar to that of the route search system 1 of the first embodiment described with reference to FIG. 1. Therefore, the route search system of the present embodiment will be described below with reference to the functional configuration of FIG. 1. Hereinafter, description will be omitted when the same processing as that of the first embodiment is performed. In the present example, an example in which the departure place and the current location of the vehicle are different will be described.

In the present embodiment, a case where a user calls a taxi to an arbitrary departure facility by operating an information terminal to move to an arbitrary destination facility will be described as an example. The user can designate an arbitrary facility as the departure place similarly to the destination. The facility to be the departure place can be designated, for example, by inputting a facility name or by designating on a map displayed on the information terminal.

When receiving information on the departure place and the destination designated by the user through operation of an information terminal such as a smartphone and position information of a vehicle to be managed, the server device 10 outputs the information to the route information generation unit 102, and transmits the route information generated by the route information generation unit 102 to the high-precision map management device 20. Here, the position information of the vehicle is position information of all vehicles managed by the present system, and includes a service state of a taxi.

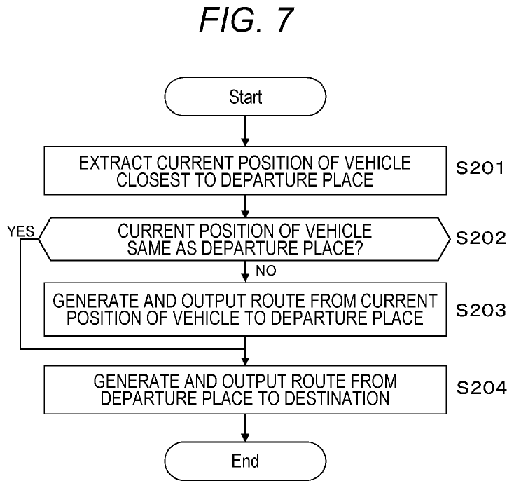

FIG. 7 is a flowchart of processing performed by the server device 10 in the route search system 1 according to the third embodiment of the present invention. Upon receiving the information on the departure place and the destination and the position information of the vehicle to be managed, the route information generation unit 102 of the server device 10 according to the present embodiment executes the processing illustrated in the flowchart of FIG. 7 accordingly.

In step S201, the departure place set by the user and the received current position of the vehicle are compared among the vehicles not in the service execution state, and the position of the closest vehicle is extracted.

In step S202, whether or not the extracted vehicle position information is the same as the departure place set by the user is determined. When the departure place and the extracted vehicle position information are the same (YES in step S202), the process proceeds to step S204, and when the departure place and the extracted vehicle position information are not the same (NO in step S202), the process proceeds to step S203.

In step S203, a route from the extracted current position of the vehicle to the departure place set by the user is searched and output as route information. In the route information here, the extracted current position of the vehicle is the departure place, and the departure place set by the user is the destination. However, it is assumed that information indicating that it is the departure place set by the user is given to the destination. Hereinafter, the route information generated in step S203 is referred to as pickup route information.

In step S204, a route from the departure place set by the user to the destination set by the user is searched and output as route information.

Upon completion of the processing of step S204, the route information generation unit 102 terminates the processing illustrated in the flowchart of FIG. 7.

Upon receiving the pickup route information, the high-precision map management device 20 converts the destination and calculates the travel route information, similarly to the first embodiment, and outputs the result.

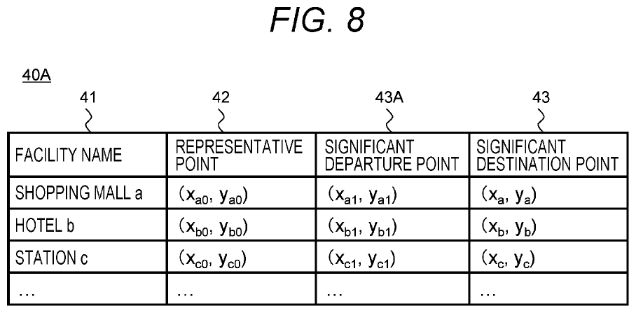

FIG. 8 is a diagram illustrating an example of a conversion table used by the destination point conversion unit 204 of the high-precision map management device 20 in the route search system 1 according to the third embodiment of the present invention. In the table of FIG. 8, the portions same as those in the table of FIG. 3 described in the first embodiment are denoted with the same reference numerals as those in FIG. 3. Therefore, the table of FIG. 8 will be described below while omitting the reference numerals common with those in FIG. 3.

The conversion table 40A illustrated in FIG. 8 includes fields of a facility name 41, a representative point 42, a significant departure point 43A, and a significant destination point 43 for each record set for every facility. The significant departure point 43A stores coordinate values of significant departure points on the high-precision map corresponding to each facility. The significant departure point indicates a place that can be entered to pick up the user, for example, a taxi stand of a facility such as a shopping mall, a station, or a hospital.

Note that the conversion table illustrated in FIG. 8 is an example, and the present invention is not limited thereto. In the route search system 1 of the present embodiment, any form of conversion table may be used in the destination point conversion unit 204 as long as a point corresponding to an arbitrary facility on the server map can be converted into a significant departure point corresponding to the facility on the high-precision map. In addition, the conversion table may be stored in advance in a place other than the destination point conversion unit 204, or may be arbitrarily acquired from another device similarly to the surrounding map information acquired by the surrounding map information acquisition unit 205.

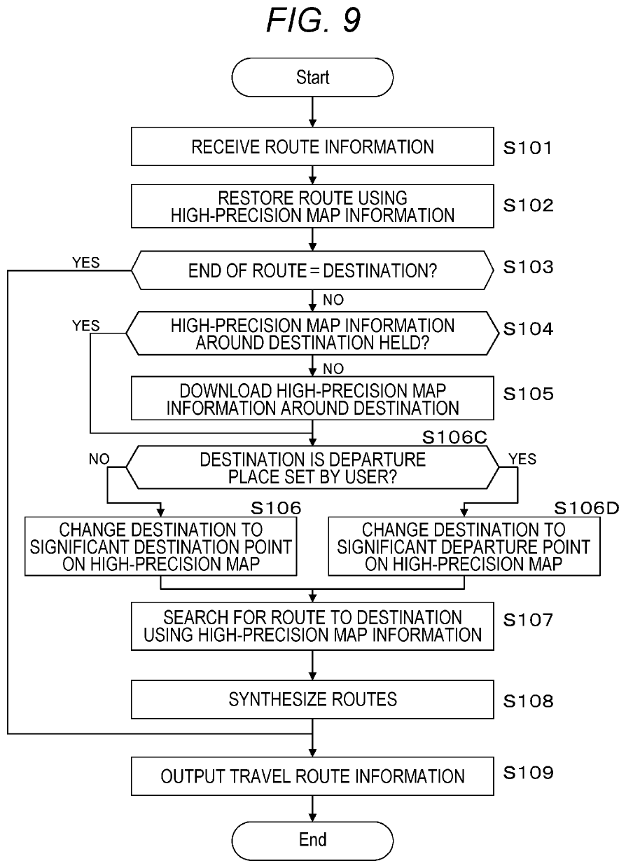

FIG. 9 is a flowchart of processing performed by the high-precision map management device 20 in the route search system 1 according to the third embodiment of the present invention. When the route information is transmitted from the server device 10, the high-precision map management device 20 of the present embodiment executes the processing illustrated in the flowchart of FIG. 9 accordingly. Note that, in the flowchart of FIG. 9, a portion that performs the same processing as the flowchart of FIG. 4 described in the first embodiment is denoted with a step number common with FIG. 4. Therefore, the flowchart of FIG. 9 will be described below while omitting the step numbers common with those in FIG. 4.

In FIG. 9, in a case where it is determined in step S103 that the end of the route is not the destination, the high-precision map information around the destination is downloaded as necessary, and then the process proceeds to step S106C. In step S106C, the high-precision map management device 20 causes the destination point conversion unit 204 to determine whether or not the destination of the received route information corresponds to the departure place set by the user. When the destination corresponds to the departure place set by the user, that is, when the route information received from the server device 10 is the pickup route information (YES in step S106C), the process proceeds to step S106D, and when the destination does not correspond to the departure place set by the user, that is, when the destination corresponds to the destination set by the user (NO in step S106C), the process proceeds to step S106.

In step S106D, the high-precision map management device 20 causes the destination point conversion unit 204 to change the destination of the route represented by the route information received in step S101 to a significant departure point on the high-precision map using, for example, the conversion table described above with reference to FIG. 8. In addition, when changing the destination, a congestion status of a significant departure point of the facility may be acquired from a server (not illustrated), and when the facility is congested, another point, for example, a significant destination point may be set as the destination.

Upon completion of the processing of step S109, the high-precision map management device 20 terminates the processing illustrated in the flowchart of FIG. 9.

The third embodiment of the present invention described above has the following operation effects.

The high-precision map management device 20 acquires, as the route information to the destination, pickup route information representing a route to a facility designated as a departure place by the user (step S101). When a part of the route to the departure place is outside the map range of the server map information (step S103: No, step S106C: Yes), the destination is changed from a point corresponding to the facility on the server map information to another point corresponding to the facility on the high-precision map information (step S106D). With this configuration, in a case where the vehicle heads to pick up the user at the departure place set by the user, the user can be picked up at an appropriate point.

Note that, in each of the embodiments described above, an example of a case where the high-precision map management device 20 having highly accurate map information for automatic driving is mounted on a vehicle, and a route to a destination is restored by the route information received from the server device 10 in the high-precision map management device 20 has been described, but the present invention is not limited thereto. For example, similar processing can be applied to a case where instead of the high-precision map management device 20, a navigation device that provides a driver of the vehicle with route guidance to a destination is mounted on the vehicle, and the route is restored in the navigation device. That is, the present invention is applicable to realize provision of an appropriate route not only in a vehicle that performs automatic driving but also in a vehicle that uses route information to a destination in an arbitrary form.

The embodiments and various modified examples described above are merely examples, and the present invention is not limited to these contents as long as the characteristics of the invention are not impaired. The present invention is not limited to the above-described embodiments and modifications, and various modifications can be made without departing from the gist of the present invention.

The disclosed content of the following priority application is incorporated herein by reference.

Japanese Patent Application No. 2019-155866 (filed on Aug. 28, 2019)

### REFERENCE SIGNS LIST

1 route search system
10 server device
20 high-precision map management device
101 server map database
102 route information generation unit
103 transmission/reception unit
201 high-precision map database
202 route information acquisition unit
203 route restoration unit
204 destination point conversion unit
205 surrounding map information acquisition unit
206 route generation unit
207 route synthesis unit

1. An electronic control device that
acquires route information to a destination based on first map information, and
when a part of the route to the destination is outside a map range of any one of the first map information and second map information having a map range different from the first map information, changes the destination to generate a route to the destination based on the second map information.

2. The electronic control device according to claim 1, wherein
the second map information is map information with higher accuracy than the first map information.

3. The electronic control device according to claim 2, wherein
the second map information is map information used for automatic driving of a vehicle.

4. The electronic control device according to claim 2, wherein
the route information represents a route to a facility designated as the destination by the user; and
in a case where a part of a route to the destination is outside a map range of the first map information, the destination is changed from a point corresponding to the facility on the first map information to another point corresponding to the facility on the second map information.

5. The electronic control device according to claim 4, comprising:
a route information acquisition unit that acquires route information including information on the destination designated by the user and information on a route to an end point set around the facility based on the first map information;
a route restoration unit that restores a first partial route to the end point based on information on a route to the end point included in the route information and the second map information;
a destination point conversion unit that converts a point corresponding to the facility on the first map information to a destination point corresponding to the facility on the second map information based on the information on the destination included in the route information;
a route generation unit that generates a second partial route from the end point to the destination point based on the second map information; and
a route synthesis unit that synthesizes the first partial route and the second partial route to generate a route to the destination.

6. The electronic control device according to claim 2, wherein
in a case where a part of the route to the destination is outside the map range of the second map information, the destination is changed to a point within a map range of the second map information.

7. The electronic control device according to claim 6, comprising:
a route information acquisition unit that acquires route information including information on a route to the destination based on the first map information;
a route restoration unit that restores a first partial route to a boundary of a map range in the second map information of the route to the destination based on the route information acquired by the route information acquisition unit and the second map information;
a destination point conversion unit that converts the destination to a destination point closest to the destination on an outer periphery of the map range in the second map information;
a route generation unit that generates a second partial route to the destination point based on the second map information; and
a route synthesis unit that synthesizes the first partial route and the second partial route to generate a route to the destination.

8. The electronic control device according to claim 1, wherein
the information on the destination in the first map information included in the route information is changed to the information on the destination in the second map information.

9. The electronic control device according to claim 2, wherein
the route information represents a route to a facility designated as a departure place by the user; and
in a case where a part of a route to the departure place is outside a map range of the first map information, the destination is changed from a point corresponding to the facility on the first map information to another point corresponding to the facility on the second map information.
